(19) United States
(12) Patent Application Publication
(10) Pub. No.: US 2026/0367681 A1
(43) Pub. Date: Nov. 19, 2026

(54) BUSBAR AND SERVER SYSTEM

(71) Applicant: Wiwynn Corporation, New Taipei City (TW)

(72) Inventors: Hao-Jhan Hong, New Taipei City (TW); CHIA-HSING HSIEH, New Taipei City (TW); KANG-BIN MAH, New Taipei City (TW)

(21) Appl. No.: 19/674,265

(22) Filed: May 12, 2026

Related U.S. Application Data
(60) Provisional application No. 63/805,976, filed on May 14, 2025.
(60) Provisional application No. 63/824,925, filed on Jun. 17, 2025.

(30) Foreign Application Priority Data
Mar. 4, 2026 (TW) 115107831

(51) Int. Cl. G06F 1/20; G06F 1/26

(52) U.S. Cl. CPC G06F 1/20; G06F 1/26

(57) ABSTRACT

A server system includes a server rack and a busbar. The server rack includes a rack, at least one server and at least one power module group. The server and the power module group are accommodated in the rack. The busbar is electrically connected to the server and the power module group. The busbar includes a casing, an electrode set and at least one flow structure. The electrode set is disposed in the casing. The flow structure is disposed in the casing and thermally coupled to the electrode set. The flow structure is provided with a plurality of heat exchange channels, a guiding channel and a communicating channel, and the heat exchange channels and the guiding channel are in fluid communication with each other through the communicating channel.

### CROSS-REFERENCE TO RELATED APPLICATIONS

This non-provisional application claims priority under 35 U.S.C. § 119(a) on Provisional Application No(s). 63/805,976 filed in U.S.A. on May 14, 2025, Provisional Application No(s). 63/824,925 filed in U.S.A. on Jun. 17, 2025, and Patent Application No(s). 115107831 filed in Taiwan, R.O.C. on Mar. 4, 2026, the entire contents of which are hereby incorporated by reference.

### TECHNICAL FIELD

The disclosure relates to a busbar and a server system.

### BACKGROUND

With the overall power of server racks increasing, conventional air-cooling methods are insufficient to dissipate heat from servers in the server racks. Therefore, most server racks currently employ liquid-cooling systems for heat dissipation. In configurations that rely entirely on liquid cooling, no airflow is driven by fans through the busbar, making it difficult for the busbar to release heat. As a result, busbars capable of being cooled by liquid have been developed.

However, the channel designs of existing liquid-cooled busbars could be unsatisfactory heat dissipation efficiency and requiring higher coolant flow rates to cool the busbars. In view of this, how to address the above issues is one of the topics in this field.

### SUMMARY

One embodiment of the disclosure provides a server system. The server system includes a server rack and a busbar. The server rack includes a rack, at least one server and at least one power module group. The server and the power module group are accommodated in the rack. The busbar is electrically connected to the server and the power module group. The busbar includes a casing, an electrode set and at least one flow structure. The electrode set is disposed in the casing. The flow structure is disposed in the casing and thermally coupled to the electrode set. The flow structure is provided with a plurality of heat exchange channels, a guiding channel and a communicating channel, and the heat exchange channels and the guiding channel are in fluid communication with each other through the communicating channel.

Another embodiment of the disclosure provides a busbar. The busbar includes a casing, an electrode set and at least one flow structure. The electrode set is disposed in the casing. The flow structure is disposed in the casing and thermally coupled to the electrode set. The flow structure is provided with a plurality of heat exchange channels, a guiding channel and a communicating channel, and the heat exchange channels and the guiding channel are in fluid communication with each other through the communicating channel.

Still another embodiment of the disclosure provides a busbar. The busbar includes a casing, an electrode set and at least one flow structure. The electrode set is disposed in the casing and includes a positive electrode and a negative electrode. The flow structure is disposed in the casing and thermally coupled to the electrode set. The flow structure is provided with a first heat exchange channel, a second heat exchange channel and a communicating channel. A fluid in the first heat exchange channel is at least thermally coupled to the positive electrode, a fluid in the second heat exchange channel is at least thermally coupled to the negative electrode, and the first heat exchange channel and the second heat exchange channel are in fluid communication with each other through the communicating channel.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a rear perspective view of a server system according to some embodiments of the disclosure;

FIG. 2 is a block diagram of a server system according to some embodiments of the disclosure;

FIG. 3 is a perspective view of a busbar according to some embodiments of the disclosure;

FIG. 4 is an exploded view of a busbar according to some embodiments of the disclosure;

FIG. 5 is a side view of a busbar according to some embodiments of the disclosure;

FIGS. 6 and 7 are cross-sectional views of a busbar according to some embodiments of the disclosure;

FIG. 8 is a rear perspective view of a server system according to some embodiments of the disclosure;

FIG. 9 is a rear perspective view of a server system according to some embodiments of the disclosure;

FIG. 10 is a rear perspective view of a server system according to some embodiments of the disclosure;

FIG. 11 is a rear perspective view of a server system according to some embodiments of the disclosure;

FIG. 12 is a block diagram of a server system according to some embodiments of the disclosure;

FIG. 13 is a block diagram of a server system according to some embodiments of the disclosure;

FIGS. 14 and 15 are cross-sectional views of a busbar according to some embodiments of the disclosure;

FIGS. 16 and 17 are cross-sectional views of a busbar according to some embodiments of the disclosure; and

FIG. 18 is a block diagram of a server system according to some embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

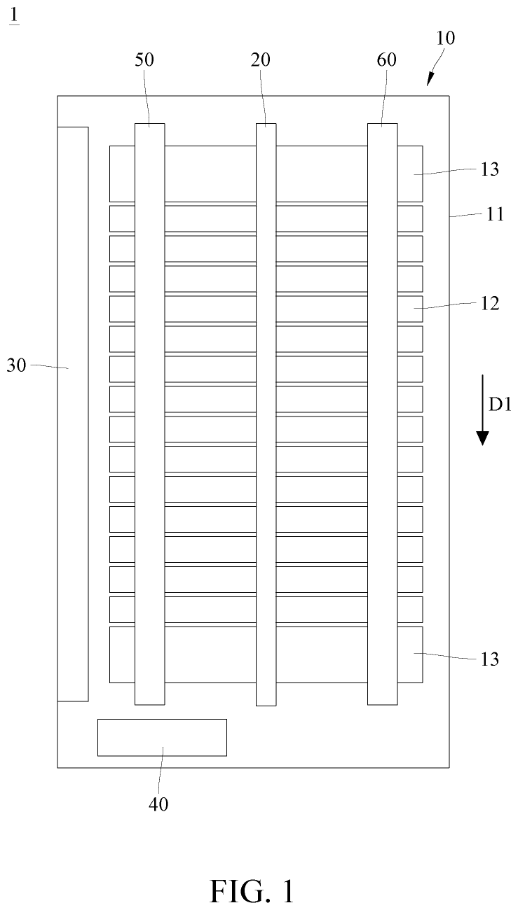

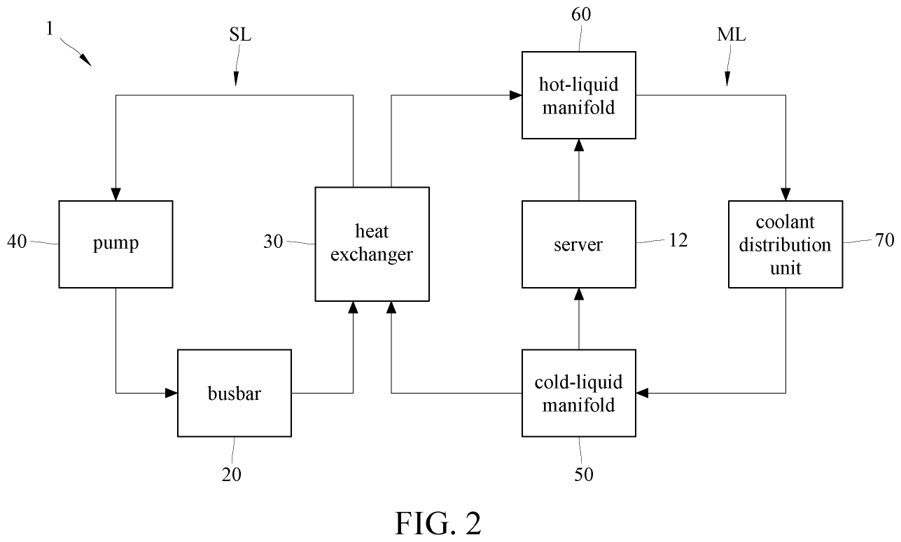

Referring to FIGS. 1 and 2, FIG. 1 is a rear perspective view of a server system 1 according to some embodiments of the disclosure, and FIG. 2 is a block diagram of the server system 1 according to some embodiments of the disclosure. In FIG. 2, the connection between two components represented by an arrow indicates that the two components are in fluid communication through a pipeline and shows the flow direction of a coolant in the pipeline. The structural features shown in FIGS. 1 and 2 can be applied to other embodiments of the disclosure.

The server system 1 includes a server rack 10 and a busbar 20. The server rack 10 includes a rack 11, at least one server 12 and at least one power module group 13. The busbar 20 is electrically connected to the server 12 and the power module group 13 to deliver power from the power module group 13 to the server 12. The power module group 13 includes one or more power modules (e.g., power shelves), each of which includes multiple power supply units (PSUs) and associated peripheral hardware.

In some embodiments, the server rack includes a plurality of servers 12 and two power module groups 13. The servers 12 are arranged horizontally along a direction from a top to a bottom of the rack 11. The servers 12 are located between the two power module groups 13, and the two power module groups 13 are respectively located adjacent to the top and the bottom of the rack 11. The two power module groups 13 are connected to the busbar 20 at locations respectively adjacent to the top and the bottom of the rack 11, such that heat concentration regions are located at these two locations.

In some embodiments, the server system 1 may further include a heat exchanger 30 and a pump 40. The pump 40, the busbar 20 and the heat exchanger 30 together form a secondary cooling loop SL for conveying a first coolant (not shown). The pump 40 drives the first coolant so that it is circulated through the secondary cooling loop SL. When the first coolant flows into the busbar 20, it can absorb heat generated by power transmitted through the busbar 20, thereby cooling the busbar 20. After leaving the busbar 20, the first coolant enters the heat exchanger 30 and is cooled, where the detailed cooling process of the first coolant in the heat exchanger 30 will be described later. Then, the cooled first coolant returns to the pump 40.

In some embodiments, the heat exchanger 30 is disposed at a rear side of the rack 11. For example, the heat exchanger 30 may be disposed at the rear side of one of side walls of the rack 11.

In some embodiments, the server system 1 may further include a cold-liquid manifold 50, a hot-liquid manifold 60 and a coolant distribution unit 70. The coolant distribution unit 70, the cold-liquid manifold 50, the hot-liquid manifold 60 and the servers 12 together form a primary cooling loop ML for conveying a second coolant (not shown). The primary cooling loop ML is independent of the secondary cooling loop SL. That is, the primary cooling loop ML and the secondary cooling loop SL do not share any flow channels or pipelines, ensuring that the second coolant in the primary cooling loop ML does not come into contact with the first coolant in the secondary cooling loop SL.

In some embodiments, the coolant distribution unit 70 may be disposed together with the servers 12 in the rack 11, thereby forming an in-rack coolant distribution unit (In-rack CDU). Alternatively, the coolant distribution unit 70 may be disposed in another rack (not shown) adjacent to the server rack 10, thereby forming an in-row coolant distribution unit (In-row CDU).

In some embodiments, the coolant distribution unit 70 may, for example, include a pump and a radiator (both not shown). The pump of the coolant distribution unit 70 drives the second coolant to the cold-liquid manifold 50. The cold-liquid manifold 50 delivers the second coolant to the servers 12 so that the second coolant absorbs heat generated by heat sources in the servers 12 and is heated. The hot-liquid manifold 60 receives the high-temperature second coolant from the servers 12 and conveys it to the coolant distribution unit 70, where it is cooled by the radiator in the coolant distribution unit 70. The second coolant in the radiator may be cooled either by air cooling or liquid cooling. For example, airflow generated by a fan may carry away heat from the second coolant in the radiator. Alternatively, the radiator may be thermally coupled to another cooling loop (such as a facility water loop) so that the heat from the second coolant in the radiator is transferred to the coolant (e.g., facility water) in the other cooling loop and thereby cooled.

In some embodiments, the cold-liquid manifold 50 and the hot-liquid manifold 60 may be in fluid communication with the heat exchanger 30. In this way, a portion of the low-temperature second coolant in the primary cooling loop ML can flow into the heat exchanger 30, allowing the high-temperature first coolant in the secondary cooling loop SL that enters the heat exchanger 30 to exchange heat with the low-temperature second coolant. As a result, the first coolant leaving the heat exchanger 30 returns to the pump 40 in a low-temperature state, and the second coolant leaving the heat exchanger 30 returns to the hot-liquid manifold 60 (i.e., the primary cooling loop ML) in a high-temperature state.

In some embodiments, the first coolant is a dielectric liquid, and the second coolant is different from the first coolant. For example, the second coolant may be a conductive liquid, but is not limited thereto. In other embodiments, the first coolant and the second coolant may each be different types of insulating liquids.

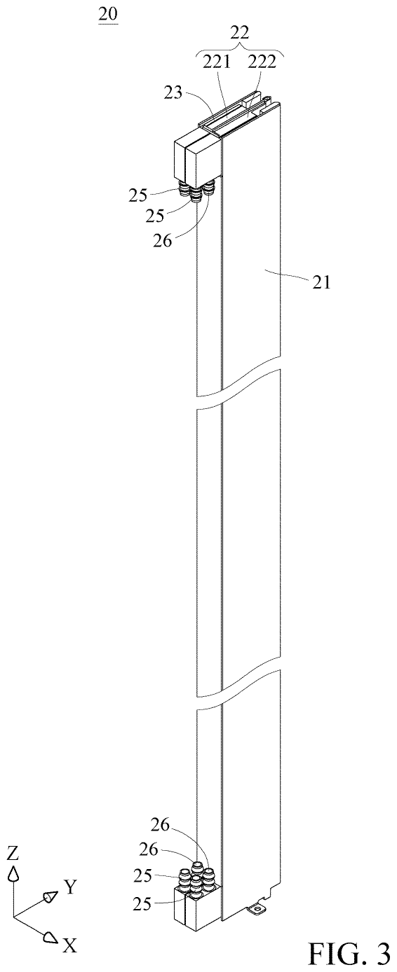

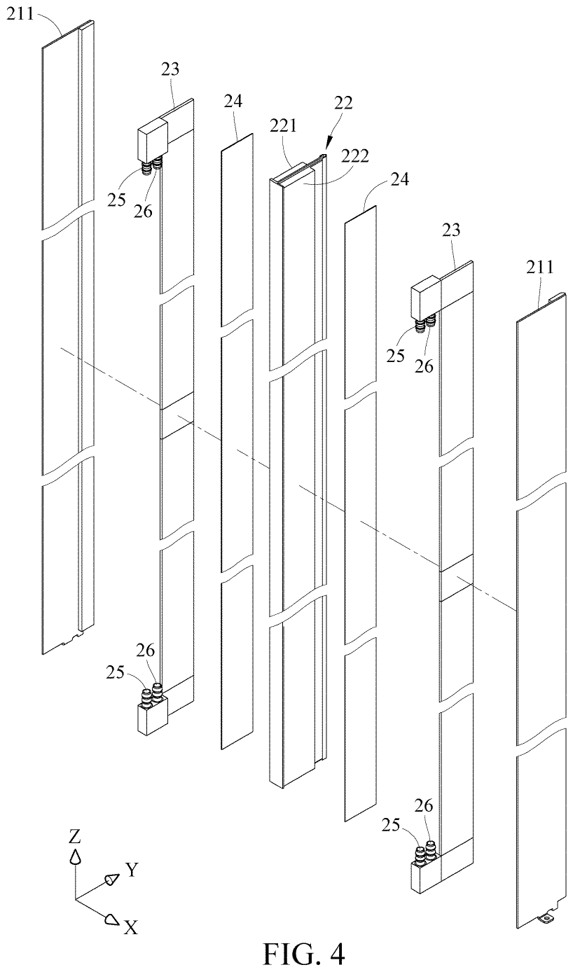

Then, referring to FIGS. 3 and 4, FIG. 3 is a perspective view of the busbar 20 according to some embodiments of the disclosure, and FIG. 4 is an exploded view of the busbar 20 according to some embodiments of the disclosure. The structural features shown in FIGS. 3 and 4 can be applied to other embodiments of the disclosure.

The busbar 20 includes a casing 21, an electrode set 22 and at least one flow structure 23. The electrode set 22 is disposed in the casing 21. The flow structure 23 is disposed in the casing 21 and is thermally coupled to the electrode set 22.

In some embodiments, the electrode set 22 includes a positive electrode 221 and a negative electrode 222, and the busbar 20 includes two flow structures. The two flow structures 23 are respectively thermally coupled to the positive electrode 221 and the negative electrode 222.

In some embodiments, the busbar 20 may further include two thermally conductive insulating materials 24. The two flow structures 23 are respectively thermally coupled to the positive electrode 221 and the negative electrode 222 through the two thermally conductive insulating materials 24. It should be noted that the two thermally conductive insulating materials 24 are optional, and may be omitted in other embodiments.

In some embodiments, the casing 21 of the busbar 20 may include two casing portions 211, which are respectively located on sides of the two flow structures 23 away from the electrode set 22. In some embodiments, the electrode set 22, the two flow structures 23 and the two casing portions 211 are all plate-shaped and together form a multilayer structure. In this way, the two casing portions 211, the two flow structures 23, the two thermally conductive insulating materials 24 and the electrode set 22 can be assembled in a simple manner. Specifically, the two thermally conductive insulating materials 24 are first respectively disposed on the positive electrode 221 and the negative electrode 222 of the electrode set 22, then the two flow structures 23 are respectively stacked on the two thermally conductive insulating materials 24, and thereafter the two casing portions 211 are stacked on the two flow structures 23 and fixed, thereby completing the assembly process.

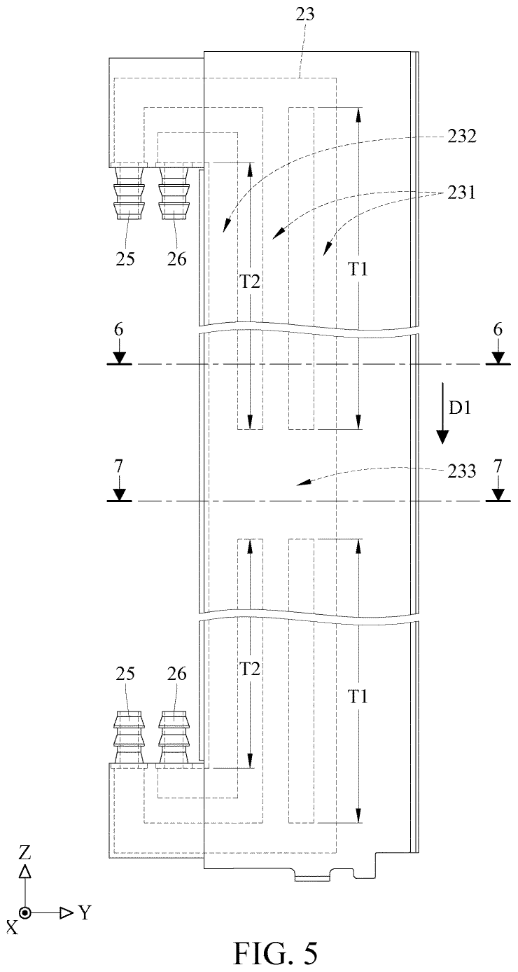

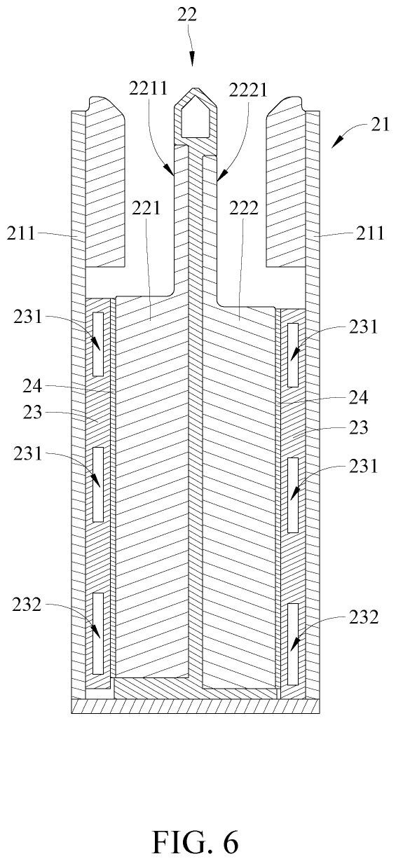

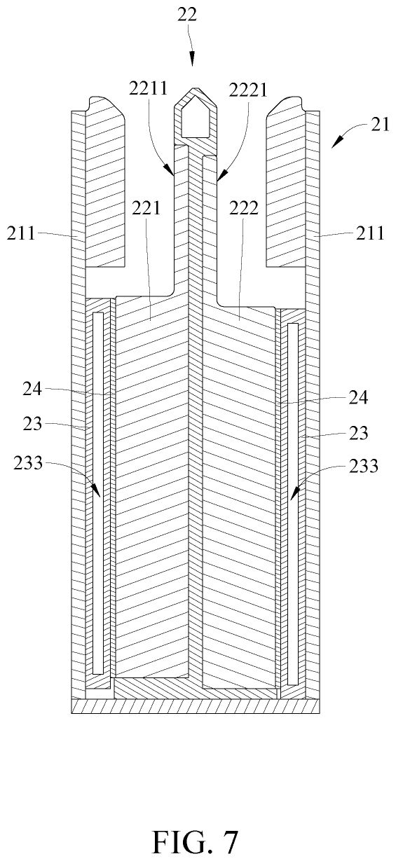

Then, referring to FIGS. 5 to 7, FIG. 5 is a side view of the busbar 20 according to some embodiments of the disclosure, and FIGS. 6 and 7 are cross-sectional views of the busbar 20 according to some embodiments of the disclosure, taken along lines 6-6 and 7-7 of FIG. 5, respectively. The structural features shown in FIGS. 5 and 7 can be applied to other embodiments of the disclosure.

In some embodiments, the two flow structures 23 have same structures; therefore, only one of them is described in detail below.

The flow structure 23 is provided with a plurality of heat exchange channels 231, a guiding channel 232 and a communicating channel 233, and the heat exchange channels 231 and the guiding channel 232 are in fluid communication with each other through the communicating channel 233.

In some embodiments, the heat exchange channels 231 extend along a direction (e.g., a direction D1) from the top toward the bottom of the rack 11 (as shown in FIG. 1). In some embodiments, the heat exchange channels 231 and the guiding channel 232 extend along an extension direction (e.g., the direction D1) of the electrode set 22.

In some embodiments, the electrode set 22 may have two contact surfaces 2211 and 2221, and the contact surfaces 2211 and 2221 of the electrode set 22 are located at portions of the electrode set 22 having relatively smaller thicknesses. In some embodiments, the contact surfaces 2211 and 2221 of the electrode set 22 are respectively located at portions of the positive electrode 221 and the negative electrode 222 having smaller thicknesses, and the two contact surfaces 2211 and 2221 face away from each other. The contact surfaces 2211 and 2221 are configured to be connected to the server 12. The guiding channel 232 is located farther from the contact surfaces 2211 and 2221 of the electrode set 22 than the heat exchange channels 231.

In some embodiments, opposite sections (e.g., upper sections and lower sections) of the heat exchange channels 231 respectively correspond to the top and the bottom of the rack 11. In some embodiments, the opposite sections of the heat exchange channels 231 adjacent to the top and the bottom of the rack 11 respectively correspond to the two power module groups 13 (as shown in FIG. 1).

In some embodiments, as shown in FIG. 5, the communicating channel 233 overlaps with portions of the heat exchange channels 231 and a portion of the guiding channel 232.

In some embodiments, the communicating channel 233 is spaced apart from opposite ends (e.g., upper ends and lower ends) of the heat exchange channels 231 by a distance T1. In some embodiments, the communicating channel 233 is spaced apart from the opposite ends of the heat exchange channels 231 by an equal distance T1. That is, the communicating channel 233 is centered with respect to the heat exchange channels 231, or the communicating channel 233 is located at the middle of the heat exchange channels 231.

In some embodiments, the communicating channel 233 is also spaced apart from two opposite ends (e.g., an upper end and a lower end) of the guiding channel 232 by a distance T2. In some embodiments, the communicating channel 233 is spaced apart from the two opposite ends of the guiding channel 232 by an equal distance T2. That is, the communicating channel 233 is centered with respect to the guiding channel 232, or the communicating channel 233 is located at the middle of the guiding channel 232.

In some embodiments, the busbar 20 may further include a plurality of first connectors 25 and a plurality of second connectors 26. The first connectors 25 are disposed on the flow structure 23 and are respectively in fluid communication with the opposite ends of the heat exchange channels 231. The first connectors 25 are connected to the pump 40 via piping. The second connectors 26 are disposed on the flow structure 23 and are respectively in fluid communication with the two opposite ends of the guiding channel 232. The second connectors 26 are connected to the heat exchanger 30 via piping. In this way, the low-temperature first coolant from the pump 40 can enter the heat exchange channels 231 through the first connectors 25 and absorb heat generated when the busbar 20 transmits power. The heated high-temperature first coolant then flows from the communicating channel 233 to the guiding channel 232 and subsequently exits the busbar 20 via the second connectors 26. The high-temperature first coolant leaving the busbar 20 then flows to the heat exchanger 30 to be cooled.

In some embodiments, the first connectors 25 in fluid communication with the heat exchange channels 231 and the second connectors 26 in fluid communication with the guiding channel 232 are independent of each other. That is, the first connectors 25 in fluid communication with the heat exchange channels 231 and the second connectors 26 in fluid communication with the guiding channel 232 are different connectors. In some embodiments, the first connectors 25 and the second connectors 26 are located at two opposite sides of the communicating channel 233 along a gravity direction (e.g., the direction D1).

In the above embodiments, the flow structure 23 is disposed in the casing 21 and thermally coupled to the electrode set 22, and the heat exchange channels 231 and the guiding channel 232 of the flow structure 23 are in fluid communication through the communicating channel 233. By this configuration, the heat dissipation efficiency of the busbar 20 can be enhanced without increasing the coolant flow rate.

In addition, because the opposite sections of the heat exchange channels 231 adjacent to the top and bottom of the rack 11 respectively correspond to the two power module groups 13, and the low-temperature first coolant from the pump 40 flows into the opposite sections of the heat exchange channels 231 (i.e., the upper sections and the lower sections), the low-temperature first coolant can directly dissipate heat at the heat concentration regions, thereby further enhancing the heat dissipation efficiency of the busbar 20. For example, please refer to Table 1, which shows simulation results of the busbar 20 and a busbar in which the flow direction of the coolant in the channels is unidirectional (e.g., from bottom to top) under the same conditions.

TABLE 1

| | busbar 20 of | busbar in which the flow direction |
|---|---|---|
| | the above | of the coolant in the channels is |
| type | embodiment | unidirectional |
| Pressure drop of | 0.43 | 1.06 |
| the busbar(psi) | | |
| degree of | 27.9 | 31.7 |
| temperature rise of | | |
| busbar (°C) | | |

As shown in Table 1, in the flow structure 23 of the busbar 20 in the above embodiment, the configuration in which the low-temperature first coolant flows into the upper and lower sections of the heat exchange channels 231 allows the low-temperature first coolant to be preferentially supplied to regions with higher heat generation (near the power module groups 13), thereby reducing the temperature rise of the busbar and achieving better heat dissipation efficiency. The busbar 20 of the above embodiment is not limited to be applied in the configuration of FIG. 1, where the two power module groups 13 are respectively adjacent to the top and bottom of the rack 11. The following provides examples for illustration.

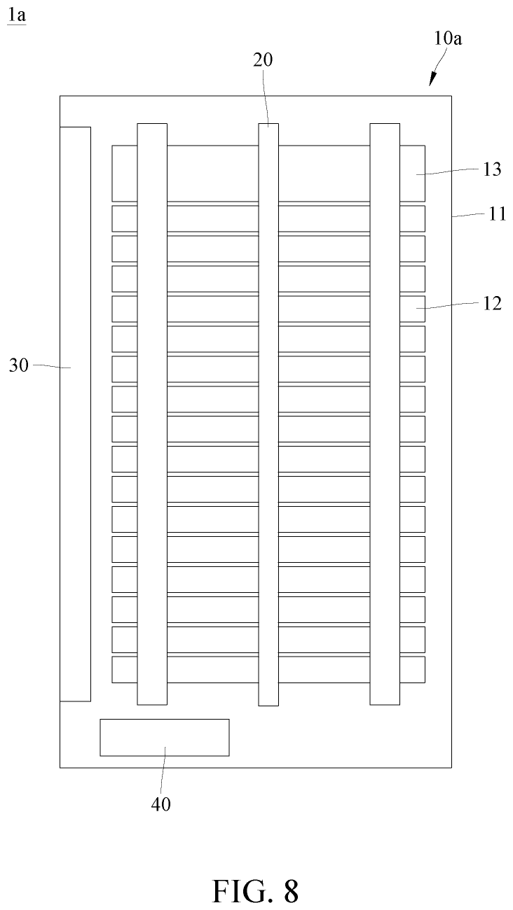

Referring to FIGS. 5 and 8, FIG. 8 is a rear perspective view of a server system 1a according to some embodiments of the disclosure. The structural features shown in FIG. 8 can be applied to other embodiments of the disclosure.

The busbar 20 of the above embodiment can be applied to a configuration of the server rack 10a having a single power module group 13 adjacent to the top of the rack 11, where this power module group 13 corresponds to the sections of the heat exchange channels 231 of the flow structure 23 near the top of the rack 11. In such a configuration, the first connector 25 near the top of the rack 11 can be connected to the pump 40 via piping to receive low-temperature first coolant from the pump 40. In this way, the low-temperature first coolant entering the sections of the heat exchange channels 231 near the top of the rack 11 can directly dissipate heat from the heat concentration region. The first connector 25 near the bottom of the rack 11 can be connected to the heat exchanger 30 via piping to deliver the high-temperature first coolant leaving the busbar 20 to the heat exchanger 30 for cooling. The second connectors 26 can be sealed without being connected to any other component.

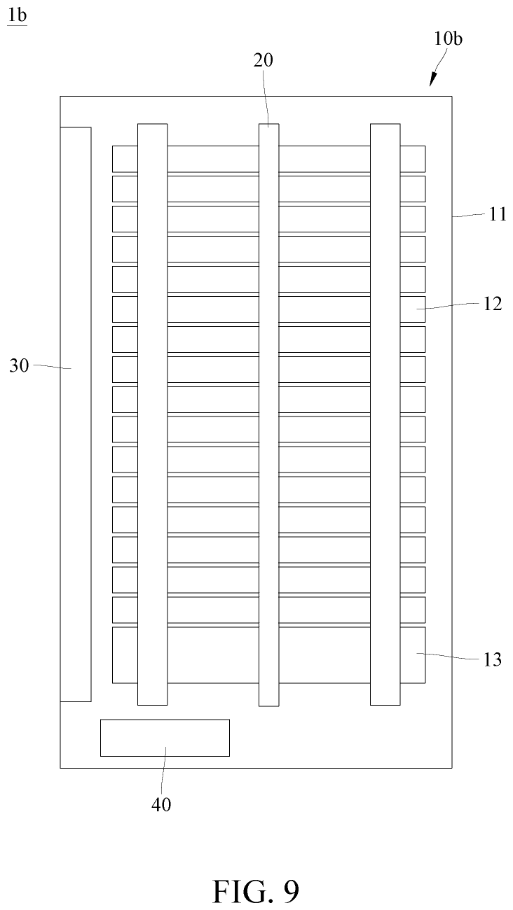

Referring to FIGS. 5 and 9, FIG. 9 is a rear perspective view of a server system 1b according to some embodiments of the disclosure. The structural features shown in FIG. 9 can be applied to other embodiments of the disclosure.

The busbar 20 of the above embodiment can be applied to a configuration of the server rack 10b having a single power module group 13 adjacent to the bottom of the rack 11, where this power module group 13 corresponds to the sections of the heat exchange channels 231 of the flow structure 23 near the bottom of the rack 11. In such a configuration, the first connector 25 near the bottom of the rack 11 can be connected to the pump 40 via piping to receive low-temperature first coolant from the pump 40. In this way, the low-temperature first coolant entering the sections of the heat exchange channels 231 near the bottom of the rack 11 can directly dissipate heat from the heat concentration region. The first connector 25 near the top of the rack 11 can be connected to the heat exchanger 30 via piping to deliver the high-temperature first coolant leaving the busbar 20 to the heat exchanger 30 for cooling. The second connectors 26 can be sealed without being connected to any other component.

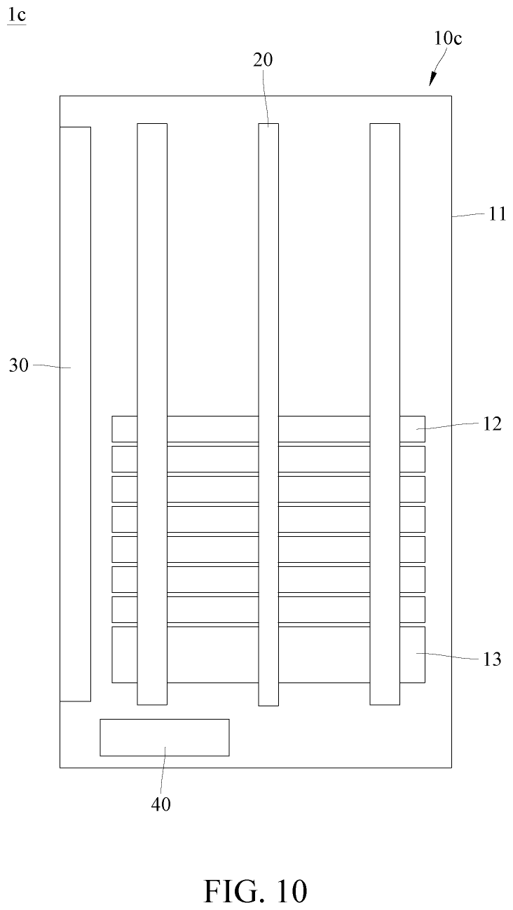

Referring to FIGS. 5 and 10, FIG. 10 is a rear perspective view of a server system 1c according to some embodiments of the disclosure. The structural features shown in FIG. 10 can be applied to other embodiments of the disclosure.

The busbar 20 of the above embodiment can be applied to a configuration of the server rack 10c having a single power module group 13 adjacent to the bottom of the rack 11, where this power module group 13 corresponds to the sections of the heat exchange channels 231 of the flow structure 23 near the bottom of the rack 11. In addition, in this server rack 10c, the rack 11 is not fully equipped with servers 12, and the servers 12 are concentrated in the lower half of the rack 11. In such a configuration, the first connector 25 near the bottom of the rack 11 can be connected to the pump 40 via piping to receive low-temperature first coolant from the pump 40. In this way, the low-temperature first coolant entering the sections of the heat exchange channels 231 near the bottom of the rack 11 can directly dissipate heat from the heat concentration region. The second connector 26 near the bottom of the rack 11 can be connected to the heat exchanger 30 via piping to deliver the high-temperature first coolant leaving the busbar 20 to the heat exchanger 30 for cooling. The first connector 25 and the second connector 26 near the top of the rack 11 can be sealed without being connected to any other component.

Similarly, in another embodiment, if the rack 11 of FIG. 8 is not fully equipped with the servers 12, and the servers 12 are concentrated in the upper half of the rack 11, the first connector 25 near the top of the rack 11 can be connected to the pump 40 via piping to receive low-temperature first coolant from the pump 40. The second connector 26 near the top of the rack 11 can be connected to the heat exchanger 30 via piping to deliver the high-temperature first coolant leaving the busbar 20 to the heat exchanger 30 for cooling. The first connector 25 and the second connector 26 near the bottom of the rack 11 can be sealed without being connected to any other component.

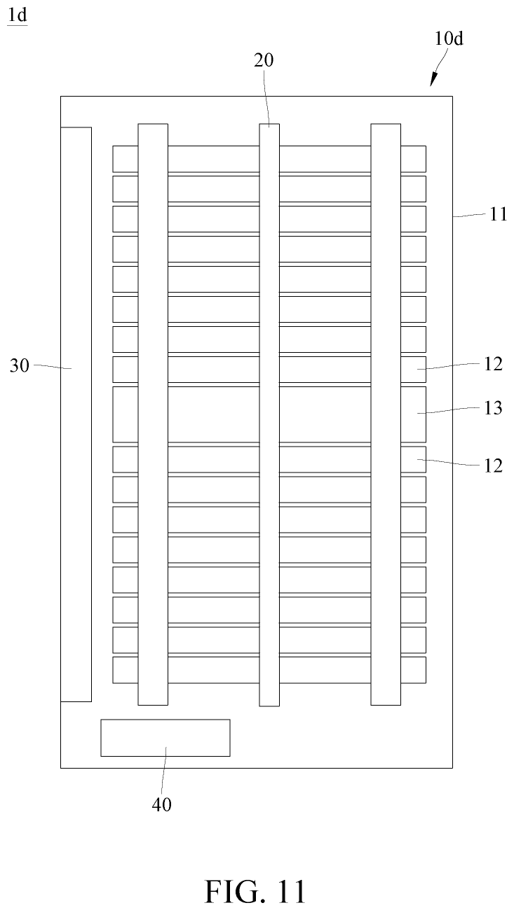

Referring to FIGS. 5 and 11, FIG. 11 is a rear perspective view of a server system according to some embodiments of the disclosure 1d. The structural features shown in FIG. 11 can be applied to other embodiments of the disclosure.

The busbar 20 of the above embodiment can be applied to a configuration of the server rack 10d having a single power module group 13 located between the servers 12, where this power module group 13 corresponds to the communicating channel 233 of the flow structure 23. In such a configuration, the second connectors 26 can be connected to the pump 40 via piping to receive low-temperature first coolant from the pump 40. In this way, the low-temperature first coolant flowing from the guiding channel 232 into the communicating channel 233 can directly dissipate heat from the heat concentration region. The first connectors 25 can be connected to the heat exchanger 30 via piping to deliver the high-temperature first coolant leaving the busbar 20 to the heat exchanger 30 for cooling.

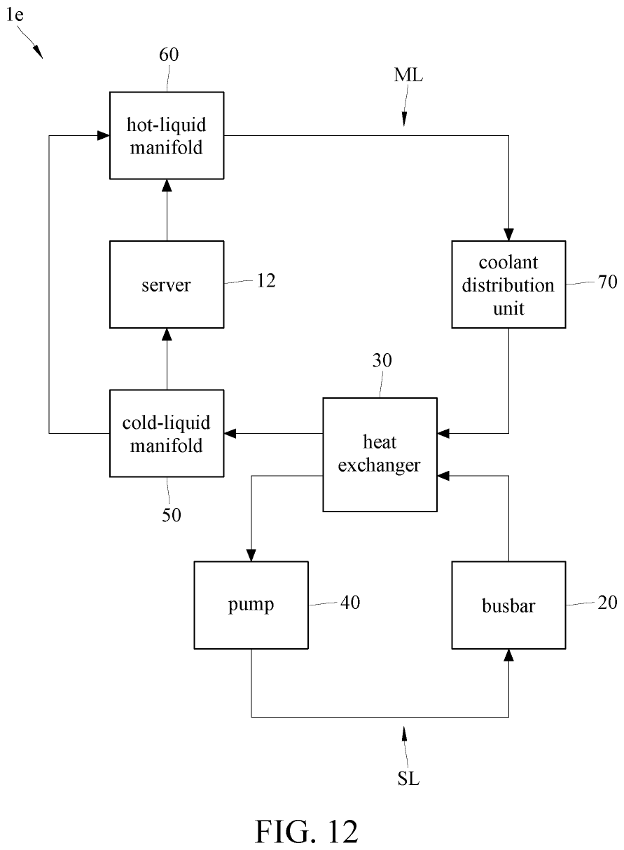

Then, referring to FIG. 12, FIG. 12 is a block diagram of a server system 1e according to some embodiments of the disclosure. The structural features shown in FIG. 12 can be applied to other embodiments of the disclosure.

The server system 1e of the embodiment shown in FIG. 12 is similar to the server system 1 of the embodiment shown in FIG. 2. The following mainly describes the differences between them, and the identical portions are not repeated.

In the server system 1e of the embodiment shown in FIG. 12, the heat exchanger 30 is in fluid communication with the cold-liquid manifold 50 and the coolant distribution unit 70, and the heat exchanger 30 is located upstream of the cold-liquid manifold 50 and downstream of the coolant distribution unit 70.

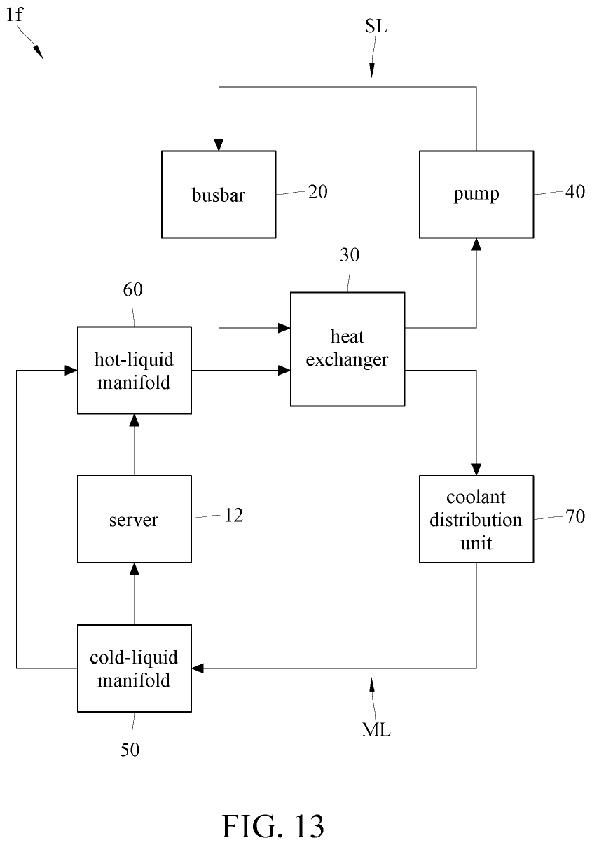

Then, referring to FIG. 13, FIG. 13 is a block diagram of a server system 1f according to some embodiments of the disclosure. The structural features shown in FIG. 13 can be applied to other embodiments of the disclosure.

The server system 1f of the embodiment shown in FIG. 13 is similar to the server system 1 of the embodiment shown in FIG. 2. The following mainly describes the differences between the them, and the identical portions are not repeated.

In the server system 1f of the embodiment shown in FIG. 13, the heat exchanger 30 is in fluid communication with the hot-liquid manifold 60 and the coolant distribution unit 70, and the heat exchanger 30 is located downstream of the hot-liquid manifold 60 and upstream of the coolant distribution unit 70.

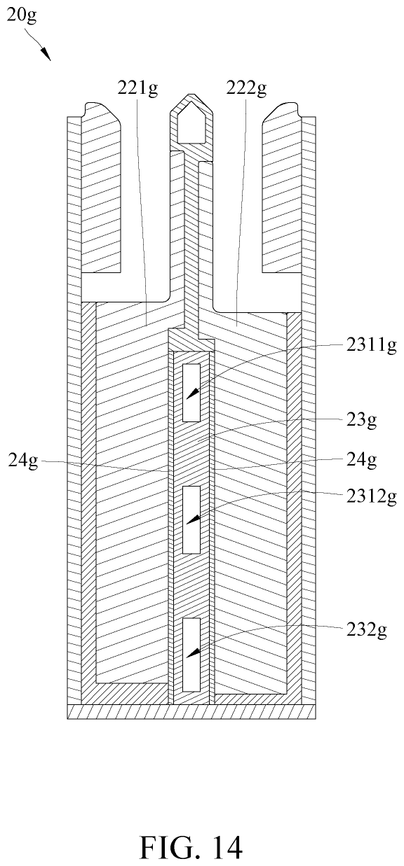

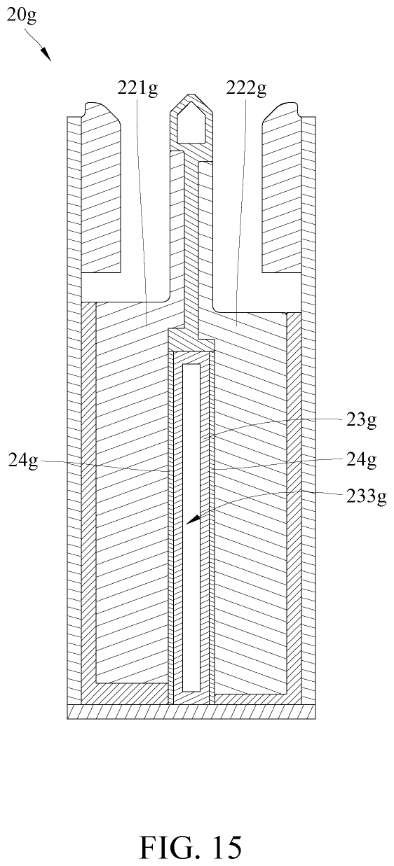

Then, referring to FIGS. 14 and 15, FIGS. 14 and 15 are cross-sectional views of a busbar 20g according to some embodiments of the disclosure. The cross-sectional views of the busbar 20g shown in FIGS. 14 and 15 are taken along the lines 6-6 and 7-7 in FIG. 5, respectively. FIG. 14 shows heat exchange channels 2311g and 2312g and a guiding channel 232g of a flow structure 23g of the busbar 20g. FIG. 15 shows a communicating channel 233g of the flow structure 23g of the busbar 20g. The structural features shown in FIGS. 14 and 15 can be applied to other embodiments of the disclosure.

The busbar 20g of the embodiments shown in FIGS. 14 and 15 is similar to the busbar 20 of the embodiments shown in FIGS. 6 and 7. The following mainly describes the differences between them, and the identical portions are not repeated.

In the busbar 20g, the busbar 20g includes a single flow structure 23g. Two opposite sides of this flow structure 23g are thermally coupled to a positive electrode 221g and a negative electrode 222g via two thermally conductive insulating materials 24g. This flow structure 23g includes a plurality of heat exchange channels 2311g, 2312g, a guiding channel 232g and a communicating channel 233g that is in fluid communication with these heat exchange channels 2311g and 2312g and the guiding channel 232g. The heat exchange channels 2311g and 2312g are respectively a first heat exchange channel 2311g and a second heat exchange channel 2312g. The fluid (i.e., the first coolant) in the first heat exchange channel 2311g is thermally coupled to both the positive electrode 221g and the negative electrode 222g, and the fluid (i.e., the first coolant) in the second heat exchange channel 2312g is also thermally coupled to both the positive electrode 221g and the negative electrode 222g.

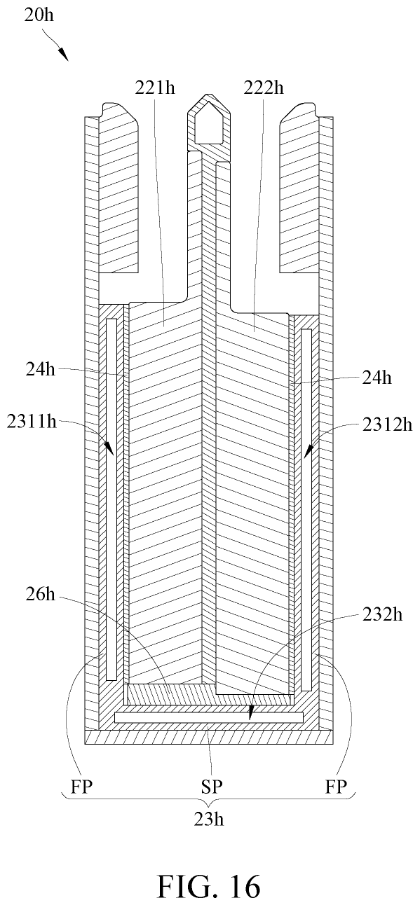

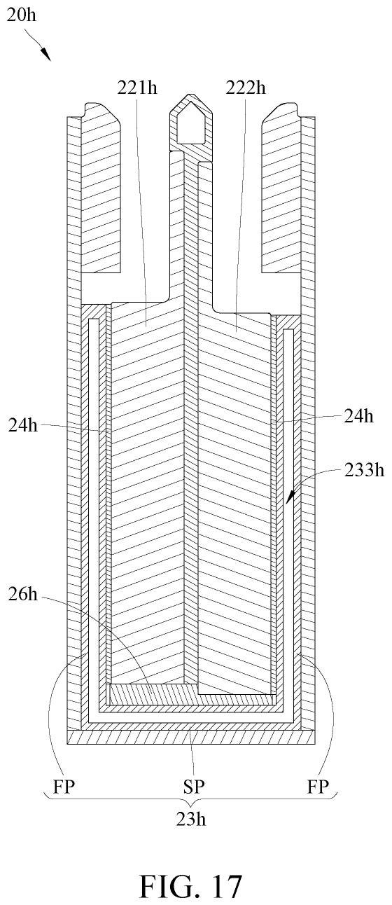

Then, referring to FIGS. 16 and 17, FIGS. 16 and 17 are cross-sectional views of a busbar 20h according to some embodiments of the disclosure. The cross-sectional views of the busbar 20h shown in FIGS. 16 and 17 are taken along the lines 6-6 and 7-7 in FIG. 5, respectively. FIG. 16 shows heat exchange channels 2311h and 2312h and a guiding channel 232h of a flow structure 23h of the busbar 20h. FIG. 17 shows a communicating channel 233h of the flow structure 23h of the busbar 20h. The structural features shown in FIGS. 16 and 17 can be applied to other embodiments of the disclosure.

The busbar 20h of the embodiments shown in FIGS. 16 and 17 is similar to the busbar 20 of the embodiments shown in FIGS. 6 and 7. The following mainly describes the differences between them, and the identical portions are not repeated.

In the busbar 20h, the busbar 20h includes a single flow structure 23h. The flow structure 23h includes two first portions FP and a second portion SP. The two first portions FP are thermally coupled to a positive electrode 221h and a negative electrode 222h, respectively, via two thermally conductive insulating materials 24h. The two first portions FP are located on the same side of the second portion SP and are connected to each other. In addition, the busbar 20h may further include an insulating material 26h, the second portion SP is thermally coupled the positive electrode 221h and the negative electrode 222h via the insulating material 26h. A thermal conductivity of the insulating material 26h is lower than that of the two thermally conductive insulating materials 24h.

In the busbar 20h, the heat exchange channels 2311h and 2312h of the flow structure 23h are a first heat exchange channel 2311h and a second heat exchange channel 2312h, respectively. The first heat exchange channel 2311h and the second heat exchange channel 2312h are located in the two first portions FP, respectively. Thus, the fluid in the first heat exchange channel 2311h is thermally coupled only to the positive electrode 221h, and the fluid in the second heat exchange channel 2312h is thermally coupled only to the negative electrode 222h.

In the busbar 20h, the guiding channel 232h of the flow structure 23h is located in the second portion SP. In addition, different portions of the communicating channel 233h of the flow structure 23h are located in the two first portions FP and the second portion SP, and the communicating channel 233h overlaps with a portion of the first heat exchange channel 2311h, a portion of the second heat exchange channel 2312h and a portion of the guiding channel 232h. Thus, the communicating channel 233h is in fluid communication with the first heat exchange channel 2311h, the second heat exchange channel 2312h and the guiding channel 232h.

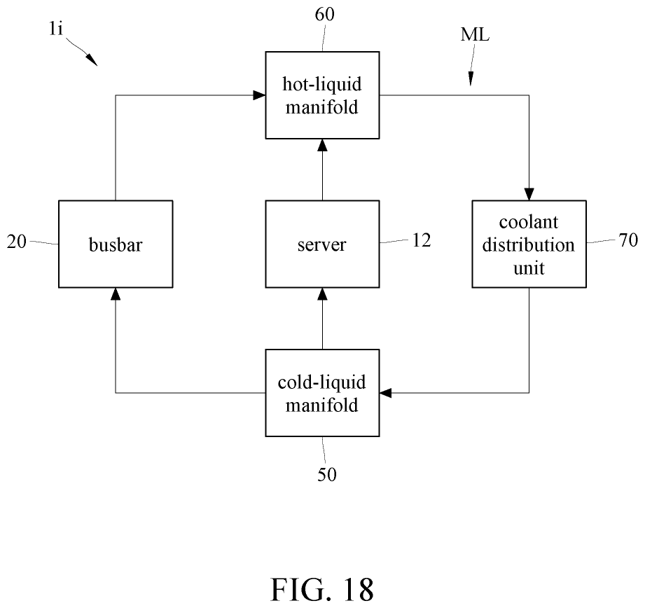

Then, referring to FIG. 18, FIG. 18 is a block diagram of a server system 1i according to some embodiments of the disclosure. The structural features shown in FIG. 18 can be applied to other embodiments of the disclosure.

The server system 1i of the embodiment shown in FIG. 18 is similar to the server system 1 of the embodiment shown in FIG. 2. The following mainly describes the differences between them, and the identical portions are not repeated.

In the server system 1i of the embodiment shown in FIG. 18, the server system 1i does not include a heat exchanger or a pump. The busbar 20 of server system 1i is in fluid communication with the cold-liquid manifold 50 and the hot-liquid manifold 60, where the busbar 20 is located downstream of the cold-liquid manifold 50 and upstream of the hot-liquid manifold 60. Thus, in the server system 1i, the conductive coolant in the primary cooling loop ML, formed by the coolant distribution unit 70, the cold-liquid manifold 50, the server 12 and the hot-liquid manifold 60, can flow into the busbar 20 to dissipate heat from the busbar 20.

According to the busbar and the server system as discussed in the above embodiments, the flow structure is disposed in the casing and thermally coupled to the electrode set, and the heat exchange channels and the guiding channel of the flow structure are in fluid communication through the communicating channel. By this configuration, the heat dissipation efficiency of the busbar can be enhanced without increasing the coolant flow rate.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A server system, comprising:
a server rack, comprising a rack, at least one server and at least one power module group, wherein the at least one server and the at least one power module group are accommodated in the rack; and
a busbar, electrically connected to the at least one server and the at least one power module group, wherein the busbar comprises:
a casing;
an electrode set, disposed in the casing; and
at least one flow structure, disposed in the casing and thermally coupled to the electrode set, wherein the at least one flow structure is provided with a plurality of heat exchange channels, a guiding channel and a communicating channel, and the plurality of heat exchange channels and the guiding channel are in fluid communication with each other through the communicating channel.

2. The server system according to claim 1, wherein the plurality of heat exchange channels extend along a direction from a top toward a bottom of the rack, opposite sections of the plurality of heat exchange channels respectively correspond to the top and the bottom of the rack, and the communicating channel of the at least one flow structure is spaced apart from opposite ends of the plurality of heat exchange channels.

3. The server system according to claim 2, wherein the communicating channel of the at least one flow structure is spaced apart from the opposite ends of the plurality of heat exchange channels by an equal distance.

4. The server system according to claim 2, wherein the at least one power module group is located adjacent to the top or the bottom of the rack, and the at least one power module group corresponds to sections of the plurality of heat exchange channels located adjacent to the top or the bottom of the rack.

5. The server system according to claim 4, wherein the at least one power module group comprises two power module groups, the two power module groups are respectively located adjacent to the top and the bottom of the rack, the two power module groups respectively correspond to the opposite sections of the plurality of heat exchange channels located adjacent to the top and the bottom of the rack, and the at least one server is located between the two power module groups.

6. The server system according to claim 2, wherein the at least one server comprises a plurality of servers, the at least one power module group is located between the plurality of servers, and the at least one power module group corresponds to the communicating channel.

7. The server system according to claim 1, further comprising a heat exchanger, a cold-liquid manifold and a hot-liquid manifold, wherein the heat exchanger is in fluid communication with the at least one flow structure to jointly form a secondary cooling loop, the cold-liquid manifold delivers a coolant to the at least one server, the hot-liquid manifold receives the coolant from the at least one server; the cold-liquid manifold, the hot-liquid manifold and the at least one server together form a primary cooling loop, and the primary cooling loop is independent of the secondary cooling loop.

8. The server system according to claim 7, wherein the cold-liquid manifold and the hot-liquid manifold are in fluid communication with the heat exchanger.

9. The server system according to claim 7, wherein the heat exchanger is in fluid communication with the cold-liquid manifold and is located upstream of the cold-liquid manifold.

10. The server system according to claim 7, wherein the heat exchanger is in fluid communication with the hot-liquid manifold and is located downstream of the hot-liquid manifold.

11. The server system according to claim 1, further comprising a cold-liquid manifold and a hot-liquid manifold, wherein the cold-liquid manifold delivers a coolant to the at least one server, the hot-liquid manifold receives the coolant from the at least one server; the cold-liquid manifold, the hot-liquid manifold and the at least one server together form a primary cooling loop, and the at least one flow structure is in fluid communication with the cold-liquid manifold and the hot-liquid manifold.

12. A busbar, comprising:
a casing;
an electrode set, disposed in the casing; and
at least one flow structure, disposed in the casing and thermally coupled to the electrode set, wherein the at least one flow structure is provided with a plurality of heat exchange channels, a guiding channel and a communicating channel, and the plurality of heat exchange channels and the guiding channel are in fluid communication with each other through the communicating channel.

13. The busbar according to claim 12, wherein the plurality of heat exchange channels and the guiding channel extend along an extension direction of the electrode set.

14. The busbar according to claim 12, wherein the electrode set has a contact surface, the contact surface is configured to be connected to a server, the guiding channel is located farther from the contact surface of the electrode set than the plurality of heat exchange channels.

15. The busbar according to claim 14, wherein the contact surface of the electrode set is located at a portion of the electrode set having a relatively smaller thickness.

16. The busbar according to claim 12, wherein the electrode set comprises a positive electrode and a negative electrode, and two opposite sides of the at least one flow structure are respectively thermally coupled to the positive electrode and the negative electrode.

17. The busbar according to claim 16, further comprising two thermally conductive insulating materials, wherein two opposite sides of the at least one flow structure are respectively thermally coupled to the positive electrode and the negative electrode via the two thermally conductive insulating materials.

18. The busbar according to claim 12, further comprising two thermally conductive insulating materials, wherein the electrode set comprises a positive electrode and a negative electrode, the at least one flow structure comprises two first portions and a second portion, the two first portions are respectively thermally coupled to the positive electrode and the negative electrode via the two thermally conductive insulating materials, and the two first portions are located on a same side of the second portion, the plurality of heat exchange channels are respectively located in the two first portions, and the guiding channel is located in the second portion.

19. The busbar according to claim 18, further comprising an insulating material, wherein the second portion is thermally coupled to the positive electrode and the negative electrode via the insulating material, and a thermal conductivity of the insulating material is lower than thermal conductivities of the two thermally conductive insulating materials.

20. The busbar according to claim 12, wherein the electrode set comprises a positive electrode and a negative electrode, and the at least one flow structure comprises two flow structures, the two flow structures are respectively thermally coupled to the positive electrode and the negative electrode.

21. The busbar according to claim 20, further comprising two thermally conductive insulating materials, wherein the two flow structures are respectively thermally coupled to the positive electrode and the negative electrode via the two thermally conductive insulating materials.

22. The busbar according to claim 12, further comprising a plurality of first connectors and a plurality of second connectors, wherein the plurality of first connectors are respectively in fluid communication with opposite ends of the plurality of heat exchange channels, and the plurality of second connectors are respectively in fluid communication with two opposite ends of the guiding channel, and the plurality of first connectors and the plurality of second connectors are mutually independent.

23. The busbar according to claim 22, wherein the plurality of first connectors and the plurality of second connectors are located at two opposite sides of the communicating channel in a direction of gravity.

24. A busbar, comprising:
a casing;
an electrode set, disposed in the casing and comprising a positive electrode and a negative electrode; and
at least one flow structure, disposed in the casing and thermally coupled to the electrode set, wherein the at least one flow structure is provided with a first heat exchange channel, a second heat exchange channel and a communicating channel, a fluid in the first heat exchange channel is at least thermally coupled to the positive electrode, a fluid in the second heat exchange channel is at least thermally coupled to the negative electrode, and the first heat exchange channel and the second heat exchange channel are in fluid communication with each other through the communicating channel.
